(19) United States
(12) Patent Application Publication
(10) Pub. No.: US 2021/0076004 A1
(43) Pub. Date: Mar. 11, 2021

(54) Universal Surveillance Footage Archive System

(71) Applicant: IGOR NEPOCHATOV, RICHBORO, PA (US)

(72) Inventor: IGOR NEPOCHATOV, RICHBORO, PA (US)

(21) Appl. No.: 16/565,369

(22) Filed: Sep. 9, 2019

(51) Int. Cl. H04N 7/18; H04N 21/4147; H04N 21/274; H04N 21/4335; G11B 27/36; H04N 5/77; G11B 27/30

(52) U.S. Cl. CPC H04N 7/18; H04N 21/4147; H04N 21/274; G11B 27/3081; G11B 27/36; H04N 5/77; H04N 21/4335

(57) ABSTRACT

A system and method for archiving digital surveillance footage is disclosed. The system being comprised of a universal software program that interacts with popular network video recording (NVR) and digital video recording (DVR) surveillance systems currently on the market (formerly known as closed circuit television—CCTV). The software saves footage to the local and/or remote servers and allow users to easily-locate data or isolate key frames of interest. An object of the invention is to enhance the efficiency of surveillance footage management and to eliminate the reliance on a particular type of the NVR or DVR which among other benefits, illiminagtes the solution lock-in. The software allows users to examine and detect any trends in file metadata and migrate footage from one CCTV system to another while preserving the continuity and independence of the video archival process.

### FIELD OF THE INVENTION

The present invention generally relates to software. More specifically, it relates to a system that interacts with proprietary surveillance packages to allow for seamless archival efficiency, archival independence and ability to store the archive either off-line or in the cloud.

### BACKGROUND

Video surveillance or CCTV is the use of video cameras to transmit a signal to a specific place or to a limited set of displays. It differs from broadcast television in that the signal is not openly transmitted—though it may employ point to point or wireless links. One of the first known CCTV systems was installed by the Siemens Company in Germany during World War II for observing V-2 rocket launches. The first CCTV system in America became available later in the early 1950s and was called Vericon. The earliest video surveillance systems were simply monitoring in real time because there was no way to record and store information. The development of reel-to-reel media enabled the recording of surveillance footage onto magnetic tape. These systems required magnetic tapes to be changed manually, which was a time consuming, expensive and unreliable process. During the 1990s, digital multiplexing was developed and allowed several cameras to record at once, as well as time lapse and motion-only recording.

While some existing CCTV solutions offer the capability to “backup” the video archive, they are not designed to enable the user to archive the backups to independent storage media or make use of the backups/archives in the future when the original CCTV system is no longer available. Current backup solutions are designed with the goal to restore the active video archive in case of an NVR system or storage failure. The invention is solving this limitation and is therefore different from the existing backup solutions.

Today CCTV technology has been enhanced with a shift toward network-based products and systems and Network Video Recorer (NVR). NVR is a specialized computer system that includes a software program that records video in a digital format to a disk drive, USB flash drive, SD memory card or other mass storage device. An NVR contains no dedicated video capture hardware. The NVR software is sometimes run on a dedicated, proprietary device, with an embedded operating system. Other NVR software implementations are installed on general-purpose Windows or Linux computers. U.S. Pat. No. 7,460,149B1 disclosed a surveillance system that ports data in specific hierarchies to external drives enhance retrieval efficiencies. Korean Patent No. KR20180122534(A) disclosed a smart terminal for controlling the NVR by forming an online or offline network. Korean Patent No. KR20180089039(A) IP NVR Security System with file compression and storage unit to enhance efficiencies. Chinese Patent No. CN103034487A disclosed NVR software compatible with conventional operating systems, however it does not incorporate wide area networks. International Patent No. WO2013185434A1 disclosed a NVR software system that enhances surveillance footage search functions but does not include universal file compatibilities.

### SUMMARY OF THE INVENTION

The device herein disclosed and described provides a solution to the shortcomings in the prior art through the disclosure of a system and method for archiving digital surveillance footage. An object of the invention is to enhance efficiencies relating to surveillance footage archival and subsequent storage of archived data while the CCTV system no longer has direct access to the archived data. Often times, such footage is limited to proprietary hardware devices or preprietary user interfaces—such interfaces can lack flexibility which can lead to inability to access the archived footage when the original system that recorded the footag is no longer available or not funcational. Because the current disclosure makes footage available to other devices and operating systems, these inefficiencies can be minimized.

Another object of this invention is to provide a means to interface with and archive proprietary files from a multitude of popular Digital Video Recorder (DVR) and NVR systems currently available on the market today.

Another object of this invention is to provide a means to extract video data from the NVR/DVR systems using various methods that are tailored to each brand and each model.

Another object of this invention is to provide a means to automatically archive the video and audio data files when the proprietary media is filled up to capacity thereby preventing footage losses due to overwriting—a common occurrence on such systems.

Another object of this invention is to provide a means to allow users to organize data on the media and allow it to be accessed and easily searchable without the reliance on the preparatory tools or hardware provided by the NVR/DVR or the storage system vendors.

Another object of this invention is to provide a method of cataloging archival footage and a means to locate files that holds content of interest.

Another object of the aforementioned invention is to provide a means to allow archiving events to be performed locally or remotely. For example, a user can specify that a surveillance feed to be backed up to a local disk drive within an office. Or, they can specify that the feed be directly uploaded to the remote (cloud etc.) network server at a remote location. Users can allow certain surveillance feed files to be stored locally and others to be stored remotely.

Another object of the invention is to provide a wider array of surveillance footage query operations depending upon the operating system the software resides upon. For example, users can query archives at the drive and file level and according to user keyword criteria in a Windows search bar.

Another object of the invention is to provide a means to extract key frames from surveillance footage. Key frames (also known as i-frames, Intra-frames etc.) represent points of a recording. By extracting and storing the key frames, users can save the space on the media (local or remote) as well as the network transmission bandwidth at the expense of losing the ability to view the interval of time between each key frame that is saved. For example, if the original video is recorded at the frequency of 10 Frames Per Second (FPS), and the invention is configured to save one (1) key FPS, the video will not contain the original nine (9) frames and will only save the last, 10^{th} frame. The resulting video will be saved at the reduce frame rate of one (1) FPS. The user will have the ability to configure any frequency of key frames such as one (1) per second, one (1) every five (5) seconds etc.

User have multiple options as to how to store these key frames. They can elect to only store the key frames on the local media (Ex. hard drives) or upload the key frames to the remote (Ex. cloud) network. They also have the option of storing surveillance footage on a local drive and store copies of key frames remotely on the cloud network or only store the key frames. In other words, storage of the full video can occur independently of key frames storage.

Another object of the invention is to provide a means of performing trend analysis on surveillance feed files using the file's metadata. Metadata, among other thing, contains the physical size of each video file and the duration of the video recording—per each video channel (if there are multiple cameras running simultaneously). With this information, the software can build a trend of how much data each camera collects over various intervals of time. When deviation from the normal trend is detected, the invention will execute some configurable action such as send the email notification to the user.

For example, camera 1 records the property of a business that is open from 9 am to 6 pm and is closed on Saturday and Sunday—most patrons visit the business on Friday. The camera file size is sensitive to the amount of the foot traffic in its view.
In this simplified example of the normal baseline, the sample resolution is 1 day (although the sample interval can be customized):
Channel 1—Mon; 10 Terabytes of footage are recorded
Channel 1—Tue; 9 Terabytes of footage are recorded
Channel 1—Wed; 9 Terabytes of footage are recorded
Channel 1—Thurs; 9 Terabytes of footage are recorded
Channel 1—Fri; 13 Terabytes of footage are recorded
Channel 1—Sat; 1 Terabytes of footage are recorded
Channel 1—Sun; 1 Terabytes of footage are recorded

During trend analysis, the software examines the average file size for channel 1 over a week. A majority of the week, cameras records approximately between 9-10 terabytes of footage during normal business hours and 1 Terabyte during weekends. Here is an example of the anomaly that the invention will be able to detect;

Channel 1—Mon; 10 Terabytes of footage are recorded
Channel 1—Tue; 9 Terabytes of footage are recorded
Channel 1—Wed; 14 Terabytes of footage are recorded
Channel 1—Thurs; 9 Terabytes of footage are recorded
Channel 1—Fri; 13 Terabytes of footage are recorded
Channel 1—Sat; 1 Terabytes of footage are recorded
Channel 1—Sun; 1 Terabytes of footage are recorded

The software understands that traffic is heaviest on Friday as more traffic generates larger file sizes (all factors remaining constant). However, Wednesday appears to be an outlier and suggests the cameras may have captured unusual activity (such as potential gang activity in the area casing the property etc.). The software observes the anomaly and automatically notifies the user for further potential investigation. The purpose of collecting the trend is to alert the end-user of deviations from common file size trends over time. The deviation can represent other problems—such as camera's view being obstructed, a change in the behavior of whatever the camera is pointing to, a failure of an NVR to record due to mechanical or software issues etc. In most cases, a significant change or deviation from the norm will be worth an investigation of the root cause.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention equipment.

FIG. 2 illustrates a representative view of the invention process.

FIG. 3 showing an embodiment of the invention process.

Other aspects of the present invention shall be more readily understood when considered in conjunction with the accompanying drawings, and the following detailed description, neither of which should be considered limiting

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

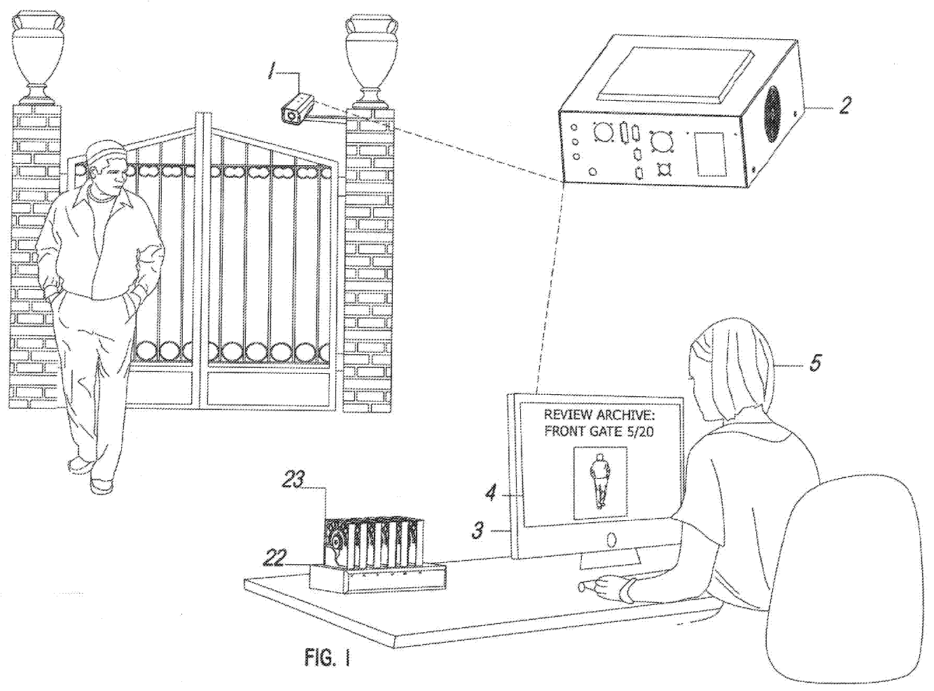

FIG. 1 shows a perspective view of the invention being used with a typical proprietary surveillance system with camera 1 and receiving unit 2. The figure showing the invention with software 4 operating on a desktop computer 5 and interacting with said receiving unit 2 (some embodiments being remote storage) by means of transmission methods such as but not limited to Ethernet cabling, Wi-Fi networks, cellular networks, local networks and wide area networks etc. The invention software 4 being written from code that may include, but not be limited to: Java, C++™, Visual Basic™, Linux™, Basic™ and the like. The software also compatible with a plurality of operating systems such as, but not limited to: Windows™ Apple™, and Android™, and compatible with a multitude of hardware platforms such as, but not limited to: personal desktops, laptops, tablets, smartphones and the like. The figure also showing an embodiment with a standalone drive bay 22 that is disposed to receive a plurality of selectively removable external hard drives 23 allowing users to store archival footage on such drives. The media (hard drives) may be inserted directly into the computer that is running the software if the form factor of the computer allows is since the software is designed to work with any storage media and is not bound to any particular form factor of the media or the way of attachment of the media. The software notifying a user when drives are approaching a state of being full and when a user should begin considering changing out drives via email messages, SMS and the like.

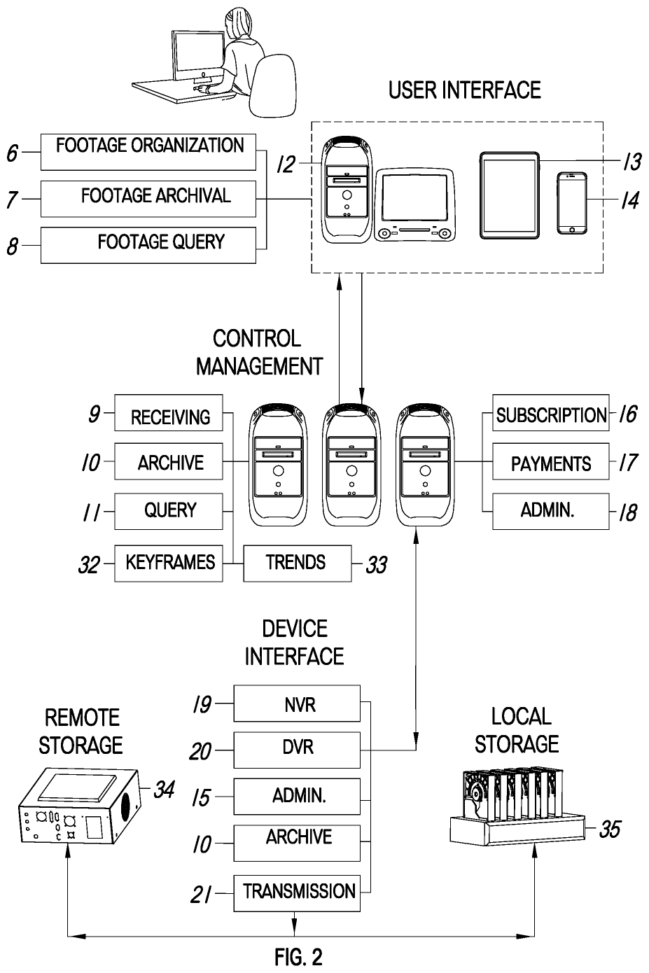

FIG. 2 illustrates a representative view of the invention process. The invention being compatible with and receiving digital surveillance footage that includes but is not limited to NVR signals 19, with file types and NVR/DVR signals 20 (MP4, MKV, and AVI etc.). The aforementioned signals being transmitted 21 to the invention software by means of but not limited to Ethernet, Wi-Fi, cellular networks, local networks and wide area networks etc. The figure showing the invention's control management system performing functions such as but not limited to: receiving surveillance feed files 9 and saving them according to user preferences; files then being archived 10 on a user's local drive or said remote (Ex. Cloud) and users having the ability to create custom file naming conventions; once files being archived, the invention software allowing users to query said files 11 based on customized criteria (directory level, external file level, as well as internal file level—date and time)—said queries 11 themselves also being recorded into historical tracks allowing users to perform similar searches without re-creating the criteria and perform administrative services 18 (reminders, notifications using SMS, text messaging and emails etc.). The figure also showing the device interface's transmission capability 21 interacting with remote storage 34 and/or local storage 35. Said device interface also performing the aforementioned administrative services 18 (reminders, notifications using SMS, text messaging and emails etc.).

The figure showing user inputs and functions including but not limited to: footage organization 6 (determining file naming convention, establishing directories etc.); footage archiving 7 (having the ability to edit and save files, or portions of files using nonproprietary operating systems); and performing footage queries 8 on said files used on predetermined criteria—including but not limited to date, time, as well as file metadata therein. Inputs also include keyframe operations 32 wherein these highlighted frames being preset by a user to be isolated and archived and later accessed both separately or embedded with surveillance video locally or remotely.

The software containing algorithms allowing trend analysis 33 to be performed on surveillance file metadata such as, but not limited to automatically detecting increases and/or differences in average file sizes across filming sessions of equal location and duration. Once such differences being detected, a user being notified (by email, SMS, text messaging etc.) of an issue that may warrant additional investigation. The figure finally showing computing devices interacting with said solution 15 including but not limited to desktop computers 12, tablets 13 and smartphones 14.

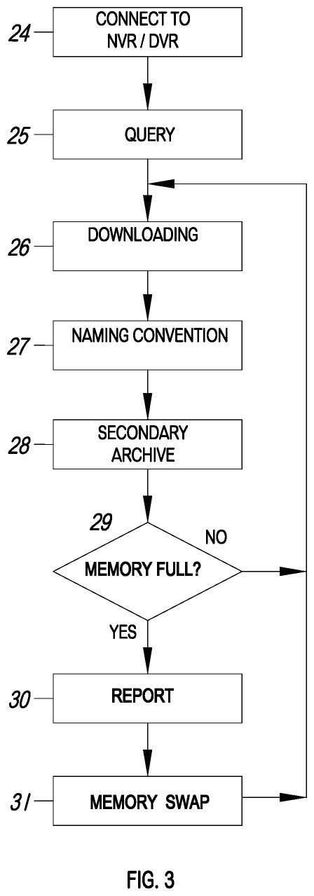

FIG. 3 showing an embodiment of the invention process. User connects invention to NVR/DVR using the method made available by NVR/DVR vendor or operating system where NVR/DVR is installed (Windows, Linux etc.) 24; NVR/DVR is queried 25 and returns the list of surveillance footage files that is available on the permanent storage of the NVR/DVR; invention software downloads the video/audio files 26 from the NVR/DVR sequentially or in groups of multiple files; invention software applies naming convention 27 according to user preferences and operating platform options (windows directories etc.); invention software saves the file (or multiple files or keyframes) in a secondary archive 28 using the folder structure as defined by the user: one example of the folder organization being the following: Top folder: Date (Example 03.23.2018), Sub folder: Camera Name or Camera Number (Example: Camera 1), Sub Folder: Video time stamp duration (Example: 3.23.2018_10.44am_56 sec.mp4).

Operation 28 being repeated until the media is filled to capacity 29. When invention software memory is filled to capacity, the invention software notifying the user (via text message, SMS etc.) and producing an electronic record 30 describes the identity of the memory drive (or other location in case of remote storage) to be swapped and the range of files archived expressed in terms of time (example: Start: 03.20.2019 10:05 am to End: 03.25.2019 13:07 pm); the user then physically swapping memory drives 31; after swapping drives, downloading NVR/DVR data resumes the operation 26 from the point in time where earlier media finalized the archive (Ex: step 8.b 03.25.2019 13:07 pm). This point in time then becomes the beginning of the next memory drive. Note that the time range describes the range of records if they are available. In other words, if the NVR/DVR did not download any files for 24 hours following the end of the download, the second download will have the time stamp of the next available record—which would be 24 hours after the end timestamp of the first download. The process repeats indefinitely as long as a user keeps swapping memory drives when they are filled up to capacity or the remote storage (cloud) has the capacity to save the data. If at any time during this process an NVR/DVR model is replaced with another type of NVR/DVR Model (which stores information in a different format) the process will remain unaffected, although the invention will have to switch/point to the new source the data. In addition, the format of the file itself and the encoding (MP4, MKV, AVI etc.) are not altered by the invention software—it aids in moving, organizing and maintaining archival data swaps while the content of the video and audio files remains unchanged with the exception of saving the keyframes only. In this case the video is changed from the original by the way of reducing the frame rate.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1.) A surveillance footage archiving system comprised of the following parts:
(a) software; and
(b) local storage
(b) a remote (cloud) network
(c) a remote (cloud) storage

2.) A method for archiving surveillance footage, the method comprised of the following:
(a) interfacing with proprietary surveillance files from popular DVR and NVR systems;
(b) organizing surveillance footage;
(c) retrieving surveillance footage;
(d) archiving surveillance footage when physical proprietary media is filled to capacity;
(e) archiving key frames;
(f) analyzing surveillance footage metadata for trends; and
(e) extracting archived footage based on content of interest.

3.) The method for archiving of surveillance footage of claim 2 wherein the archiving further being performed locally or remotely via the remote (cloud) network of claim 1.

4.) The method for archiving of surveillance footage of claim 2 wherein the organizing of surveillance depending upon the operating system the software resides upon.

5.) The method for archiving of surveillance footage of claim 2 wherein the archiving of key frames can be independent, or embedded with, the surveillance footage.

6.) The method for achieving of surveillance footage of claim 2 wherein the trends in surveillance file metadata being furthermore comprised of automatically examining and notifying the user of file size differences which suggest footage content differences.
